(19) United States
(12) Patent Application Publication
(10) Pub. No.: US 2014/0159685 A1
(43) Pub. Date: Jun. 12, 2014

(54) CONTROL DEVICE AND POWER SUPPLY DEVICE

(71) Applicant: FUJITSU SEMICONDUCTOR LIMITED, Yokohama-shi (JP)

(72) Inventors: Yuji ITO, Hachiouji (JP); Masato YOKOMAKU, Yokohama (JP)

(73) Assignee: FUJITSU SEMICONDUCTOR LIMITED, Yokohama-shi (JP)

(21) Appl. No.: 14/062,716

(22) Filed: Oct. 24, 2013

(30) Foreign Application Priority Data
Dec. 11, 2012 (JP) 2012-270727

(51) Int. Cl. H02M 3/156

(52) U.S. Cl. CPC H02M 3/156
USPC 323/282

(57) ABSTRACT

A control device includes: a control circuit that controls a power supply circuit by a feedback of an output from an output terminal, the power supply circuit having a first transistor, the first transistor including gallium nitride material and having a source and a drain connected so that one of the source and the drain is connected to a first power supply and an other of the source and the drain is connected to the output terminal; and a first terminal via which a first control signal output by the control circuit is output to a gate of the first transistor.

### CROSS-REFERENCE TO RELATED APPLICATION

This application is based upon and claims the benefit of priority of the prior Japanese Patent Application No. 2012-270727, filed on Dec. 11, 2012, the entire contents of which are incorporated herein by reference.

### FIELD

A certain aspect of the embodiments discussed herein is related to a control device and a power supply device.

### BACKGROUND

As a power supply device for voltage conversion, there are known a switching regulator (for example, DC-DC converter) and a linear regulator (for example, a low dropout regulator). In the DC-DC converter, current supplied from a power source is charged in a capacitor via an inductor. A transistor switches to convert the current to a voltage.

It is known to use a hetero junction FET (Field Effect Transistor) between the power supply device and the load (see Japanese Laid-Open Patent Publication No. 2011-200016, for example).

If the power supply voltage of the power supply device becomes lower than the voltage of the output terminal, current inversely flows from the output terminal to the power supply terminal.

### SUMMARY

According to an aspect of the present invention, there is provided a control device including: a control circuit that controls a power supply circuit by a feedback of an output from an output terminal, the power supply circuit having a first transistor, the first transistor including gallium nitride material and having a source and a drain connected so that one of the source and the drain is connected to a first power supply and an other of the source and the drain is connected to the output terminal; and a first terminal via which a first control signal output by the control circuit is output to a gate of the first transistor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a circuit diagram of a power supply device in accordance with a first comparative example, and FIG. 1B is a diagram of a rectangular wave;

FIGS. 2A through 2D are timing charts of turning-on and turning-off of transistors in response to control signals output by a control circuit;

FIG. 3 is a diagram that describes a problem of the first comparative example;

FIG. 4 is a circuit diagram of a power supply device in accordance with a second comparative example;

FIG. 5 is a circuit diagram of a power supply device in accordance with a first embodiment;

FIG. 6 is a circuit diagram of a power supply device in accordance with a second embodiment;

FIGS. 7A and 7B are circuit diagrams of exemplary protection circuits;

FIG. 8 is a circuit diagram of a power supply device in accordance with a third embodiment;

FIG. 9 is a circuit diagram of a power supply device in accordance with a fourth embodiment;

FIG. 10 is a circuit diagram of a power supply device in accordance with a fifth embodiment;

FIG. 11 is a circuit diagram of a power supply device in accordance with a sixth embodiment;

FIG. 12 is a circuit diagram of a power supply device in accordance with a variation of the sixth embodiment;

FIG. 13 is a circuit diagram of a power supply device in accordance with a seventh embodiment;

FIG. 14 is a circuit diagram of a power supply device in accordance with a variation of the seventh embodiment;

FIG. 15 is a circuit diagram of a power supply device in accordance with an eighth embodiment;

FIG. 16 is a circuit diagram of a power supply device in accordance with a ninth embodiment;

FIG. 17 is a circuit diagram of a power supply device in accordance with a tenth embodiment;

FIGS. 18A through 18C are cross-sectional views of resistors; and

FIG. 19 is a circuit diagram of a power supply system in accordance with an eleventh embodiment.

### DESCRIPTION OF EMBODIMENTS

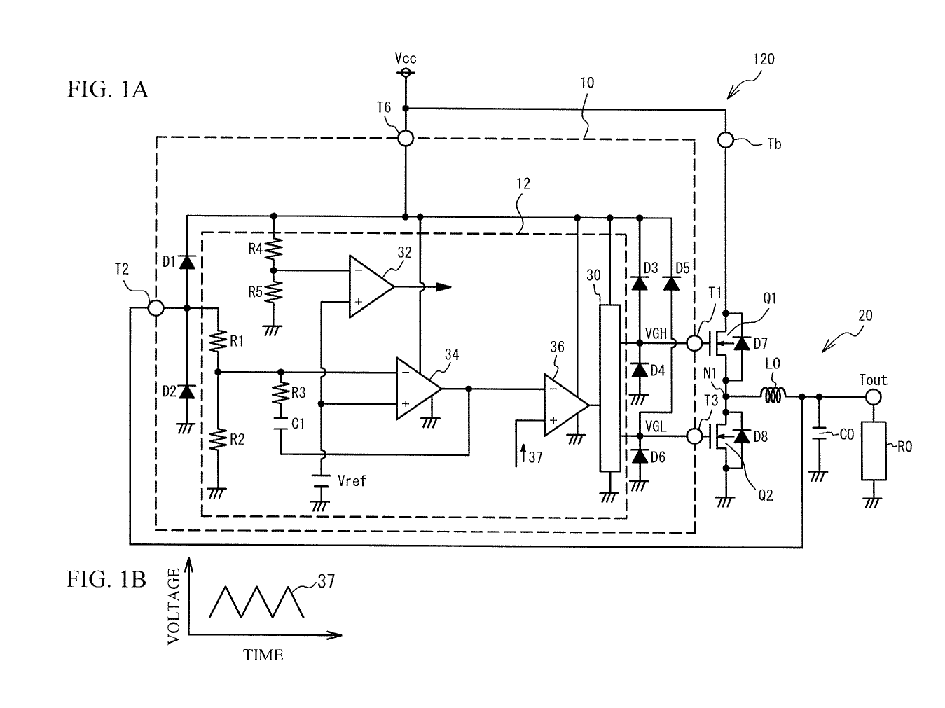

First, a power supply device in accordance with a comparative example is described. A first comparative example is an exemplary DC-DC converter. FIG. 1A is a circuit diagram of a power supply device in accordance with the first embodiment. A power supply device 120 includes a control device 10 and a power supply circuit 20. The power supply circuit 20 includes a transistor Q1 (first transistor), a transistor Q2 (second transistor), an inductor L0, and a capacitor C0. The drain of the transistor Q1 is electrically connected to a power supply terminal Tb connected to a power supply Vcc (first power supply), and the source thereof is electrically connected to a node N1. The drain of the transistor Q2 is electrically connected to the node N1, and the source thereof is electrically connected to ground (second power supply having a voltage lower than that of the first power supply). One end of the inductor L0 is electrically connected to the node N1, and the other end is electrically connected to an output terminal Tout. One end of the capacitor C0 is electrically connected to the output terminal Tout, and the other end thereof is electrically connected to the ground. A load R0 is connected between the output terminal Tout and the ground. The transistors Q1 and Q2 are n-type MOSFETs (Metal Oxide Semiconductor FETs), and parasitic diodes D7 and D8 are formed between the sources and the drains. The parasitic diodes D7 and D8 are forwardly connected in the source-to-drain directions.

The control device 10 includes a control circuit 12, diodes D1 through D6, a terminal T1 (first terminal), another terminal T2 (second terminal), yet another terminal T3 (third terminal), and a further terminal T6. The control device 10 may be formed on a single semiconductor chip such as a silicon substrate. The control circuit 12 controls the power supply circuit 20 by a feedback of the voltage of the output terminal Tout. If a surge current flows to the terminals T1, T2 and T3, the diodes D1 through D6 form a protection circuit that prevents the surge current from flowing to the control circuit 12 and causes the surge current to flow to the power supply Vcc and the ground. The terminals T1, T2, T3 and T6 are electrically connected to the gate of the transistor Q1, the output terminal Tout, the gate of the transistor Q2 and the power supply Vcc, respectively. The terminal T1 is used to apply a control signal VGH output by the control circuit 12 to the gate of the transistor Q1. The terminal T2 is used to receive the voltage of the output terminal Tout. The terminal T3 is used to apply a control signal VGL output by the control circuit 12 to the gate of the transistor Q2. A voltage supplied to the control circuit 12 is applied to the terminal T6 from the power supply Vcc.

The power supply voltage applied to the terminal T6 is divided by resistors R4 and R5, and a divided voltage thus generated is applied to the negative input terminal of a comparator 32, while a reference voltage Vref is applied to the positive input terminal of the comparator 32. The output of the comparator 32 is input to a power supply shutdown circuit. The comparator 32 outputs a high level when the voltage of the terminal T6 is equal to or lower than a predetermined or reference value. The power supply shutdown circuit shuts down part of the power supply to the control circuit 12 when the voltage of the terminal T6 is equal to or lower than the reference value. Thus, the voltage of the terminal T6 is decreased to prevent the control circuit 12 from malfunctioning. The voltage obtained by dividing the voltage of the output terminal Tout applied to the terminal T2 by resistors R1 and R2 is applied to the negative input terminal of a comparator 34, and the reference voltage Vref is applied to the positive input terminal of the comparator 34. A capacitor C1 and a resistor R3 are connected in series between the output and the negative input of the comparator 34. Thus, the comparator 34 outputs a high level when a voltage defined by smoothing the voltage of the terminal T2 is equal to or smaller than a reference value.

The output of the comparator 34 is applied to the negative input terminal of the comparator 36, and a triangular wave 37 is applied to the positive input terminal of the comparator 36. FIG. 1B illustrates an exemplary triangular wave. As illustrated in FIG. 1B, the triangular wave 37 is a wave in which the voltage has a triangular shape with respect to time. This may be applied to the other figures. The comparator 36 provides a control part 30 with a PWM signal (Pulse Width Modulation) obtained by subjecting the voltage of the output terminal Tout to the pulse width modulation. The control part 30 outputs the control signals VGH and VGL to the terminals T1 and T3 in accordance with the PWM signal, respectively.

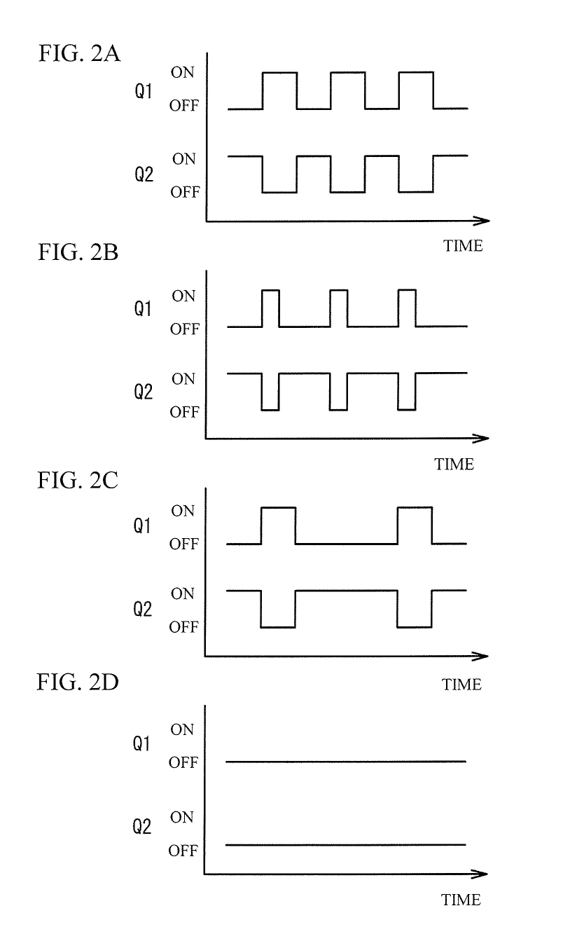

FIGS. 2A through 2D are timing charts of operations of the transistors Q1 and Q2 responsive to the control signals that are output by the control circuit 12. Referring to FIG. 2A, the turn-on timing of the transistor Q1 and the turn-off timing of the transistor Q2 are almost 180 degrees out of phase. That is, the control circuit 12 outputs the control signals VGH and VGL so that the transistor Q2 is turned off while the transistor Q1 is turned on and the transistor Q2 is turned on while the transistor Q1 is turned off. Referring to FIG. 2B, the control circuit 12 controls the control signals VGH and VGL so that the on duration of the transistor Q1 is made shorter when the voltage of the output terminal Tout becomes higher.

As the current that flows through the load R0 is smaller, the ratio of power loss due to switching of the transistors Q1 and Q2 is higher. With the above in mind, the switching frequency is lowered as illustrated in FIG. 2C. Thus, the number of switching of each of the transistors Q1 and Q2 is decreased, and the power loss due to switching may be suppressed. Referring to FIG. 2D, if the current that flows through the load R0 decreases, the transistors Q1 and Q2 are kept off until the voltage of the output terminal Tout becomes equal to a constant value. It is thus possible to suppress the power loss due to switching of the transistors Q1 and Q2.

While both the transistors Q1 and Q2 are kept off, the voltage of the power supply Vcc may be lowered, whereby the power loss is further suppressed.

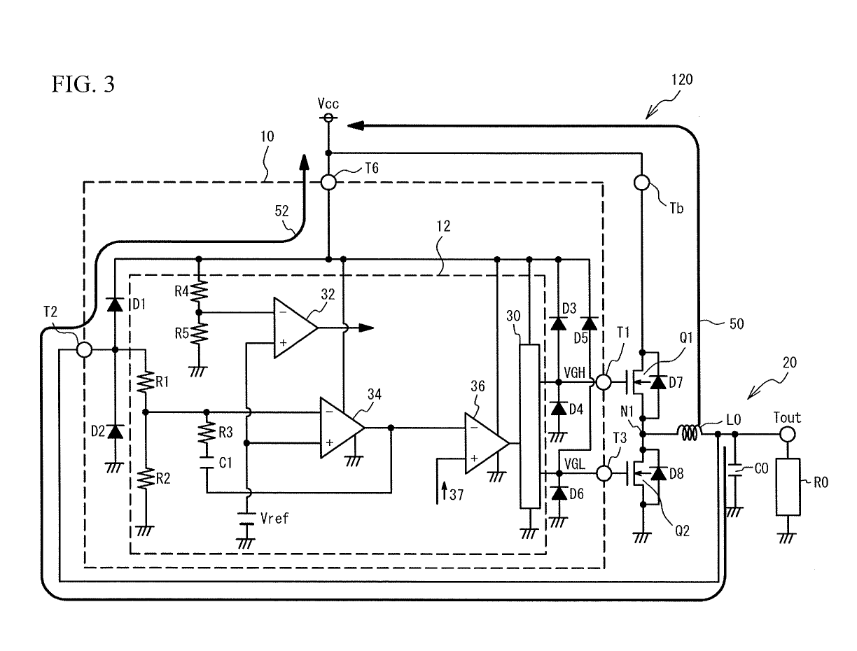

FIG. 3 describes a problem of the first comparative example. Referring to FIG. 3, a power supply device 120 has a structure that is the same as that of FIG. 1, and a description of the structure is omitted here. When the voltage of the power supply Vcc becomes lower than the voltage of the output terminal Tout, currents inversely flow from the output terminal Tout to the power supply Vcc via the diodes D7 and D1, as indicated by arrows 50 and 52. In order to suppress the inverse currents, an inverse-current prevention circuit such as a diode may be provided between the power supply Vcc and the terminal T5 (fifth terminal) and/or between the power supply Vcc and the power supply terminal Tb. However, the insertion of the inverse-flow prevention circuits may result in a voltage drop across the diode, and may increase the power loss.

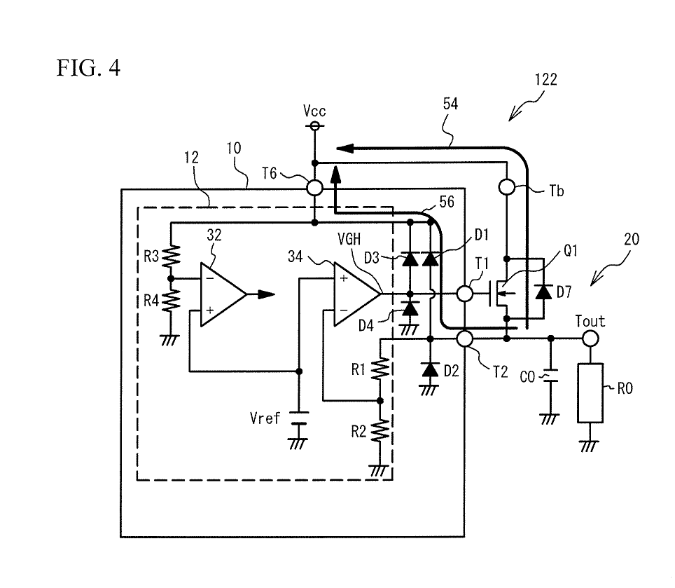

A second comparative example is an exemplary linear regulator. FIG. 4 is a circuit diagram of a power supply device in accordance with the second comparative example. A power supply device 122 includes the control device 10 and the power supply circuit 20. The power supply circuit 20 includes the transistor Q1 and the capacitor C0. The source of the transistor Q1 is connected to the output terminal Tout, and the drain is connected to the power supply terminal Tb. The transistor Q1 is an n-type MOSFET. A parasitic diode Q7 is connected between the source and the drain of the transistor Q1. One end of the capacitor C0 is connected to the output terminal, and the other end is connected to the ground. The capacitor C0 is used for smoothing. The load R0 is connected between the output terminal Tout and the ground.

The control device 10 includes the control circuit 12, diodes D1 through D4 and the terminals T1, T2 and T6. The control circuit 12 includes the comparators 32 and 34. The control device 10 is formed on a single semiconductor chip such as a silicon substrate. The control circuit 12 controls the power supply circuit 20 by a feedback of the voltage of the output terminal Tout. If a surge current flows to the terminals T1 and T2, the diodes D1 through D4 form a protection circuit that prevents the surge current from flowing to the control circuit 12 and causes the surge current to flow to the power supply Vcc or the ground. The terminals T1, T2 and T6 are electrically connected to the gate of the transistor Q1, the output terminal tout and the power supply Vcc, respectively. The terminal T1 is used to apply the control signal VGH output by the control circuit 12 to the gate of the transistor Q1. The terminal T2 is used to receive the voltage of the output terminal Tout. The voltage supplied to the control circuit 12 from the power supply is applied to the terminal T6.

The function of the comparator 32 is the same as that employed in the first comparative example, and a description thereof is omitted here. The voltage of the output terminal Tout applied to the terminal T2 is divided by the resistors R1 and R2, and a divided voltage thus obtained is applied to the negative input terminal of a differential amplifier 34, while the reference voltage Vref is applied to the positive input terminal of the differential amplifier 34. The output of the differential amplifier 34 is connected to the gate of the transistor Q1 via the terminal T1. Thus, the differential amplifier 34 supplies a voltage depending on the difference between the reference voltage Vref and the voltage of the output terminal Tout to the gate of the transistor Q1. As the voltage of the output terminal Tout is lower, the output voltage of the differential amplifier 34 is larger. Therefore, the conductance between the source and the drain of the transistor Q1 becomes smaller. This raises the voltage of the output terminal Tout. A higher voltage of the output terminal Tout results in a larger conductance between the source and the drain of the transistor Q1. Thus, the voltage of the output terminal Tout decreases. In this manner, the voltage of the output terminal Tout is kept constant.

As in the case of the first comparative example, when the voltage of the power supply Vcc becomes lower than the voltage of the output terminal Tout, currents inversely flow from the output terminal Tout to the power supply Vcc via the diodes D7 and D1, as indicated by arrows 54 and 56.

Now, a description is given of embodiments that suppress the inverse current flows from the output terminal Tout to the power supply Vcc.

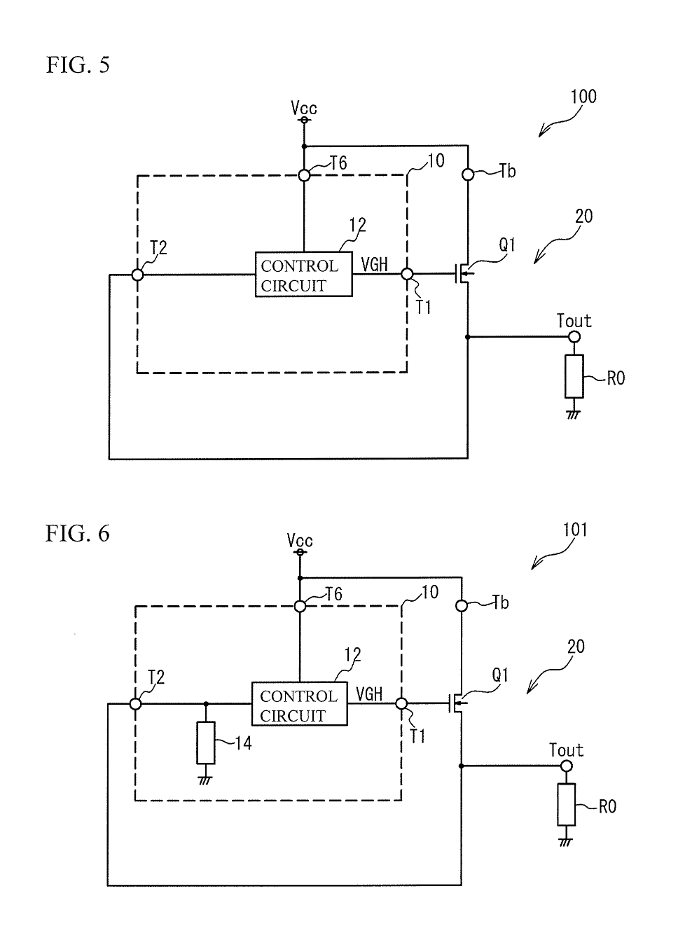

FIG. 5 is a circuit diagram of a power supply device in accordance with a first embodiment. Referring to FIG. 5, a power supply device 100 includes the control device 10 and the power supply circuit 20. The power supply circuit 20 includes transistor Q1. Either the source or drain of the transistor Q1 is connected to the power supply terminal Tb, and the other is connected to the output terminal Tout. The transistor Q1 is a transistor including GaN. For example, the transistor Q1 is configured to have an aluminum gallium nitride/gallium nitride (AlGaN/GaN) hetero structure that is formed on a substrate and to have a channel layer realized by the GaN layer. The substrate may be made of sapphire, silicon carbide (SiC), gallium nitride (GaN), silicon (Si) or the like. The transistor Q1 may be normally off or on. The load R0 is connected between the output terminal Tout and the ground.

The control device 10 includes the control circuit 12, and the terminals T1, T2 and T6. The control circuit 12 controls the power supply circuit 20 by a feedback of the output (for example, voltage) of the output terminal Tout applied to the terminal T2. The terminal T1 is used to apply the control signal VGH output by the control circuit 12 to the gate of the transistor Q1. The terminal T2 is connected to the output terminal Tout. The terminal T6 is connected to the power supply Vcc. The control circuit 12 may be similar to that employed in the first comparative circuit.

According to the first embodiment, the transistor Q1 is a transistor including GaN between the source and the drain. This structure prevents the formation of the parasitic diode D7 that is formed in the first comparative example. It is thus possible to suppress the inverse current flow from the output terminal Tout to the power supply terminal Tb even if the voltage of the power supply Vcc is lower than that of the output terminal Tout.

FIG. 6 is a circuit diagram of a power supply device in accordance with a second embodiment. Referring to FIG. 6, a power supply device 101 has the control device 10 including a protection circuit 14. The protection circuit 14 is connected to the terminal T2 and the ground. The protection circuit 14 is a circuit that prevents a surge current applied to the terminal T2 to the power supply Vcc and causes the surge current to the ground. The other structures are similar to those of the first embodiment illustrated in FIG. 5, and a description thereof is omitted here.

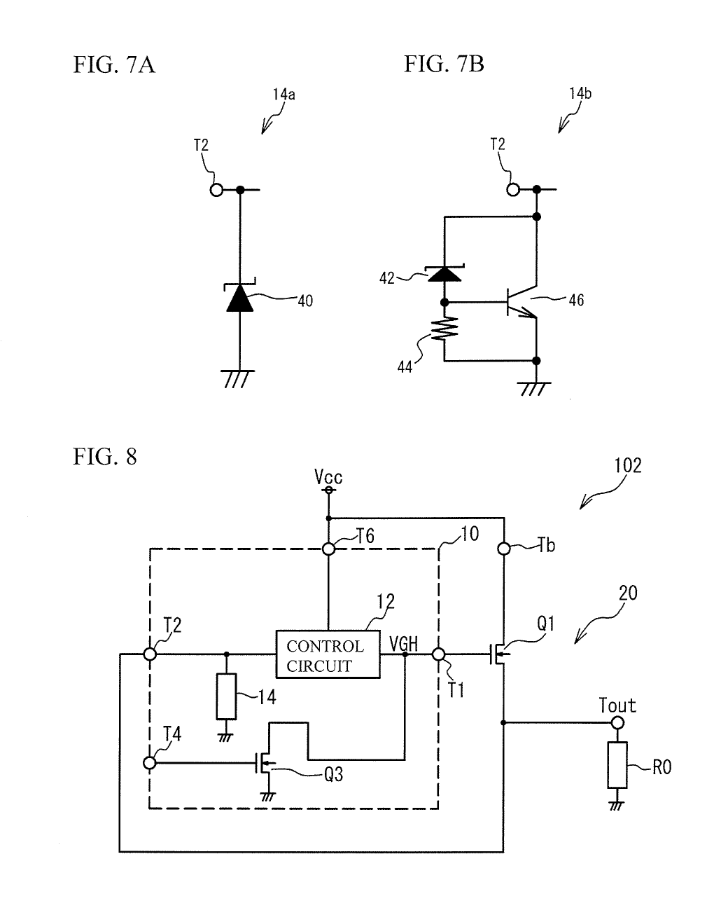

FIGS. 7A and 7B are circuit diagrams of examples of the protection circuit 14. As illustrated in FIG. 7A, a protection circuit 14a includes a Zener diode 40. The cathode of the Zener diode 40 is connected to the terminal T2, and the anode thereof is connected to the ground. As illustrated in FIG. 7B, a protection circuit 14b includes a Zener diode 42, a resistor 44 and a transistor 46. The collector of the transistor 46 is connected to the terminal T2, and the emitter thereof is connected to the ground. The cathode of the Zener diode 42 is connected to the terminal T2, and the anode thereof is connected to the base of the transistor 46. One end of the resistor 44 is connected to the base of the transistor 46, and the other end thereof is connected to the ground. The protection circuit 14 may be a circuit other than the protection circuits 14a and 14b.

According to the second embodiment, the protection circuit 14 prevents the surge current applied to the terminal T2 from flowing to the power supply Vcc and causes the surge current to flow to the ground. It is thus possible to suppress the inverse current flow from the output terminal Tout to the power supply Vcc even if the voltage of the power supply Vcc is lower than the voltage of the output terminal Tout.

FIG. 8 is a circuit diagram of a power supply device in accordance with a third embodiment. Referring to FIG. 8, a power supply device 102 includes the control device 10 including a transistor Q3. The drain of the transistor Q3 is connected to the terminal T1, and the source thereof is connected to the ground, the gate thereof being connected to a terminal T4 (fourth terminal). The transistor Q3 functions as a switch that is turned on/off by a control signal applied to the terminal T4. The other structures are the same as those of the second embodiment illustrated in FIG. 6, and a description thereof is omitted here.

In the aforementioned second embodiment, the control signal VGH is a signal that turns onf/off the transistor Q3. Thus, the control signal VGH is higher than the ground potential in some cases when turning off the transistor Q3. According to the third embodiment, the transistor Q3 is connected between the terminal T1 and the ground. This arrangement makes it possible to set the terminal T1 approximately equal to the ground potential by turning on the transistor Q3. A switch other than the transistor may be employed between the terminal T1 and the ground.

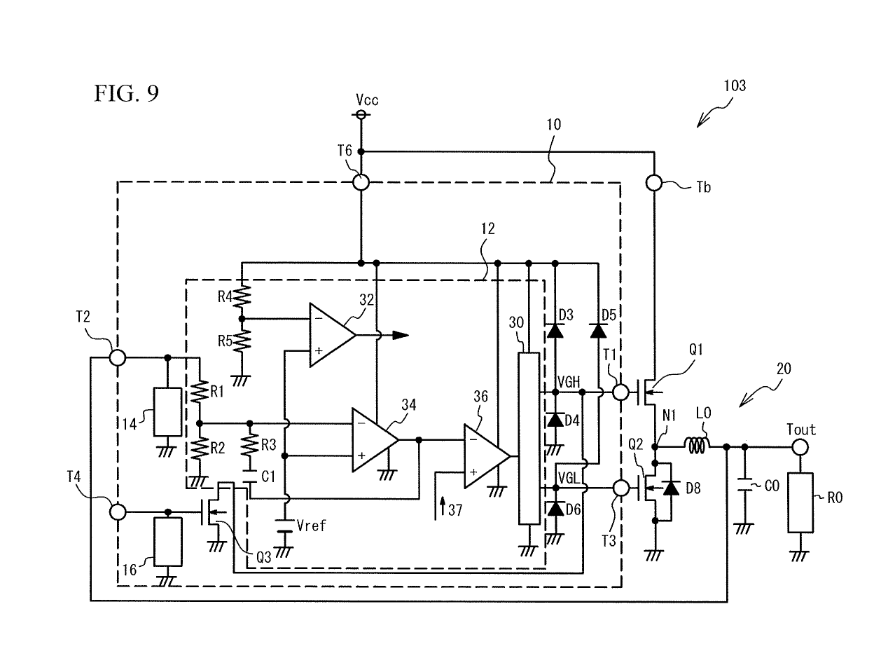

Fourth embodiments through seventh embodiments are exemplary DC-DC converters. FIG. 9 is a circuit diagram of a power supply device in accordance with the fourth embodiment. Referring to FIG. 9, a power supply device 103 employs a transistor including GaN as the transistor Q1. The power supply device 103 uses the protection circuit 14 that causes the surge current to flow to the ground to thus prevent it from flowing to the power supply Vcc. The power supply device 103 includes the transistor Q3 arranged so that the drain is connected to the terminal T1, and the source is connected to the ground, the gate being connected to the terminal T4. There is a protection circuit 16 that causes the surge current applied to the terminal T4 to thus prevent the flow of the surge current to the power supply Vcc. The other structures of the fourth embodiment are similar to those of the first comparative example, and a description thereof is omitted here.

According to the fourth embodiment, as in the case of the first embodiment, the transistor Q1 is a transistor that includes GaN having no polarity between the source and the drain. The use of the transistor Q1 thus configured makes it possible to suppress the inverse flow of current from the output terminal Tout to the power supply terminal Tb. One of the source and the drain of the transistor Q2 is connected to the other of the source and the drain of the transistor Q1, and the other of the transistor Q2 is connected to the ground. The transistor Q2 may be a transistor including GaN or an FET using a silicon substrate such as an n-type MOSFET. Also, as in the case of the second embodiment, the protection circuit 14 is employed. It is thus possible to suppress the inverse flow of current from the output terminal Tout to the power supply Vcc. Further, as in the case of the third embodiment, the transistor Q3 is used. It is thus possible to set the terminal T1 approximately equal to the ground potential when the voltage of the power supply Vcc is lower. Thus, the power consumption is reduced. The transistor Q3 may be a normally-off n-type MOSFET. The protection circuit 16 causes the surge current applied to the terminal T4 to flow to the ground, not to the Vcc. It is thus possible to suppress the inverse flow of current from the terminal T4 to the power supply Vcc even if the voltage of the power supply Vcc becomes lower than that of the terminal T4. The protection circuit 16 may be configured as illustrated in FIG. 7A or 7B. Preferably, the transistors Q2 and Q3 are normally-off transistors. The normally-off transistors Q2 and Q3 avoid the use of the negative power supply.

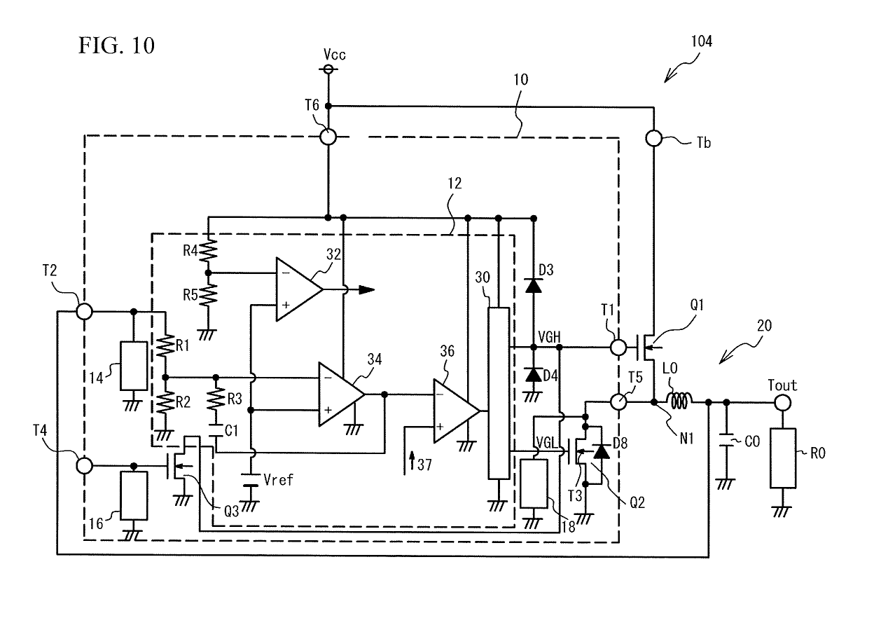

FIG. 10 is a circuit diagram of a power supply device in accordance with the fifth embodiment. Referring to FIG. 10, a power supply device 104 includes the transistor Q2 and a protection circuit 18. The protection circuit 18 causes surge current applied to the terminal T5 to flow to the ground to thus prevent it from flowing to the power supply Vcc. The protection circuit 18 may be configured as illustrated in FIG. 7A or 7B. The other structures of the fifth embodiment are the same as those of the fourth embodiment, and a description thereof is omitted here.

According to the fifth embodiment, the control device 10 has the transistor Q2. Since the transistor Q2 is not required to be a transistor that includes GaN, the transistor Q2 may be formed in the chip in which the control device 10 is formed. The transistor Q2 may be a MOSFET including a silicon substrate.

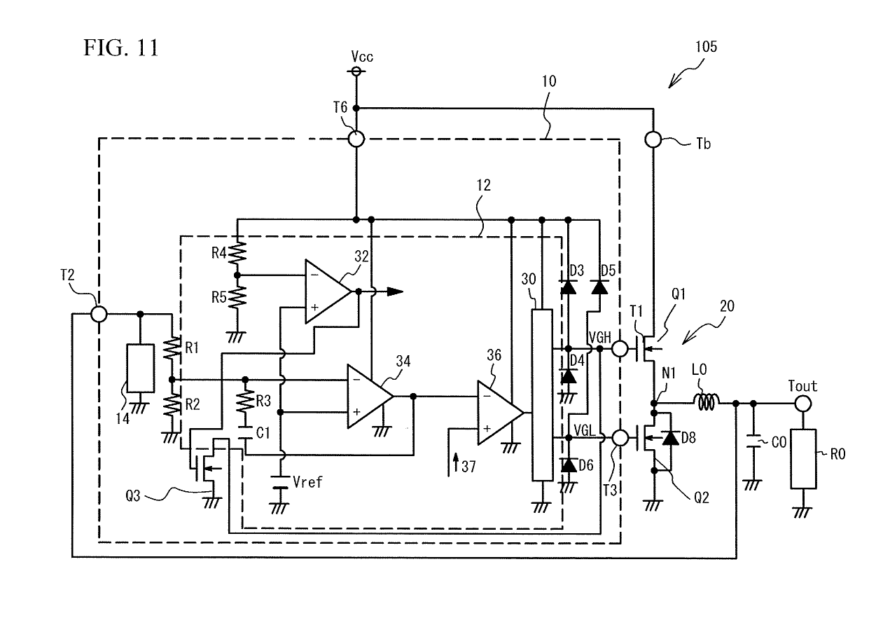

FIG. 11 is a circuit diagram of a power supply device in accordance with the sixth embodiment. Referring to FIG. 11, a power supply device 105 is configured so that the output of the comparator 32 is input to the gate of the transistor Q3. The other structures of the sixth embodiment are the same as those of the fourth embodiment, and a description thereof is omitted here.

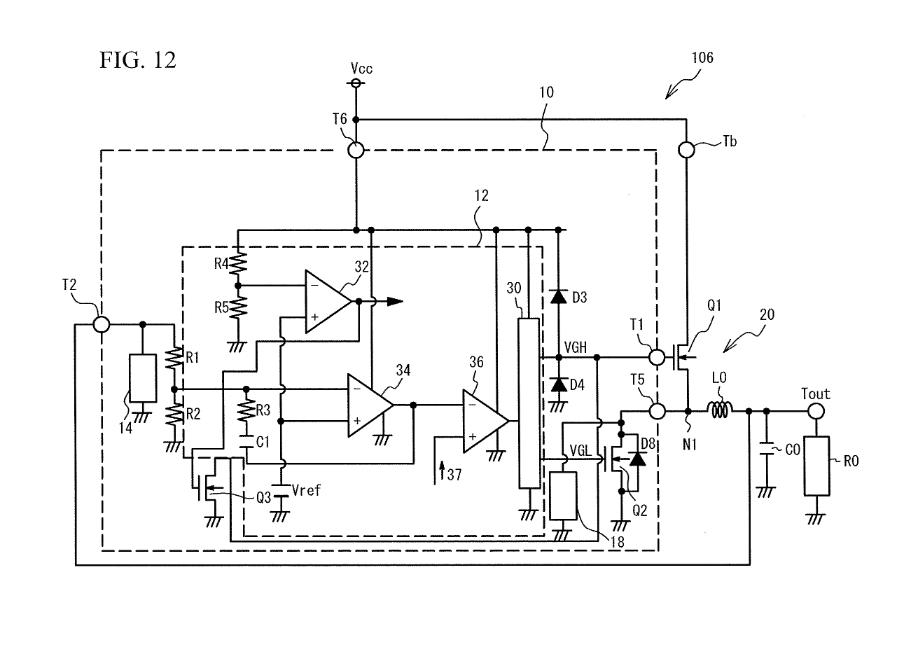

FIG. 12 is a circuit diagram of a power supply device in accordance with a variation of the sixth embodiment. Referring to FIG. 12, a power supply device 106 is configured to have the control device 10 that includes the transistor Q2 and the protection circuit 18. For example, the transistor Q2 is formed in a semiconductor chip in which the control device 10 is formed. The other structures of the variation are the same as those of the sixth embodiment illustrated in FIG. 11, and a description thereof is omitted here.

According to the sixth embodiment and its variation, the transistor Q3 may be controlled by using the output of the comparator 32 that shuts down part of the power supply to the control circuit 12.

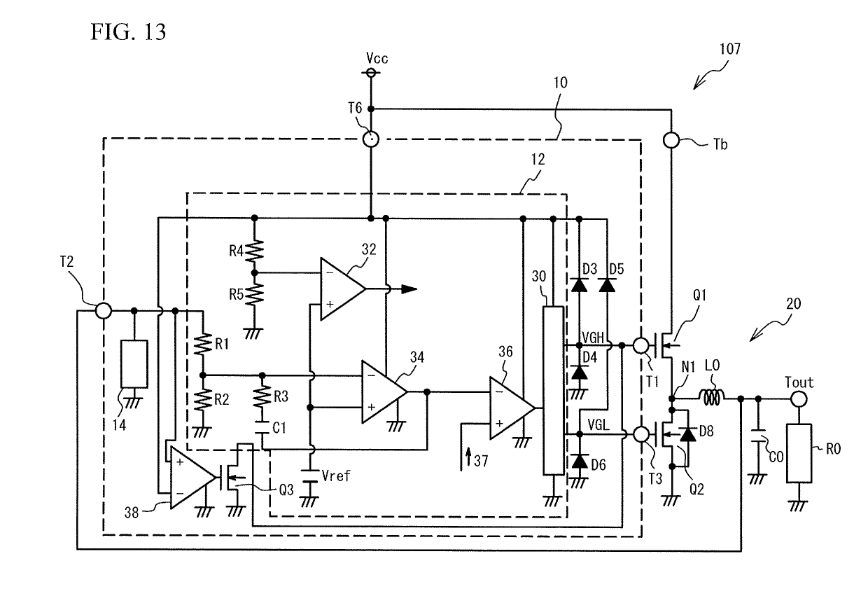

FIG. 13 is a circuit diagram of a power supply device in accordance with the seventh embodiment. Referring to FIG. 13, a power supply device 107 is configured to have the control device 10 that includes a comparator 38. The negative input terminal of the comparator 38 is connected to the terminal T6, and the positive input terminal is connected to the terminal T3. The comparator 38 outputs the high level to the gate of the transistor Q3 when the voltage of the power supply Vcc is equal to or lower than the voltage of the terminal T2. Thus, the transistor Q3 sets the terminal T1 to the ground potential when the voltage of the power supply Vcc becomes equal to or lower than the voltage of the terminal T2. The other structures of the seventh embodiment are the same as those of the fourth embodiment illustrated in FIG. 9, and a description thereof is omitted here.

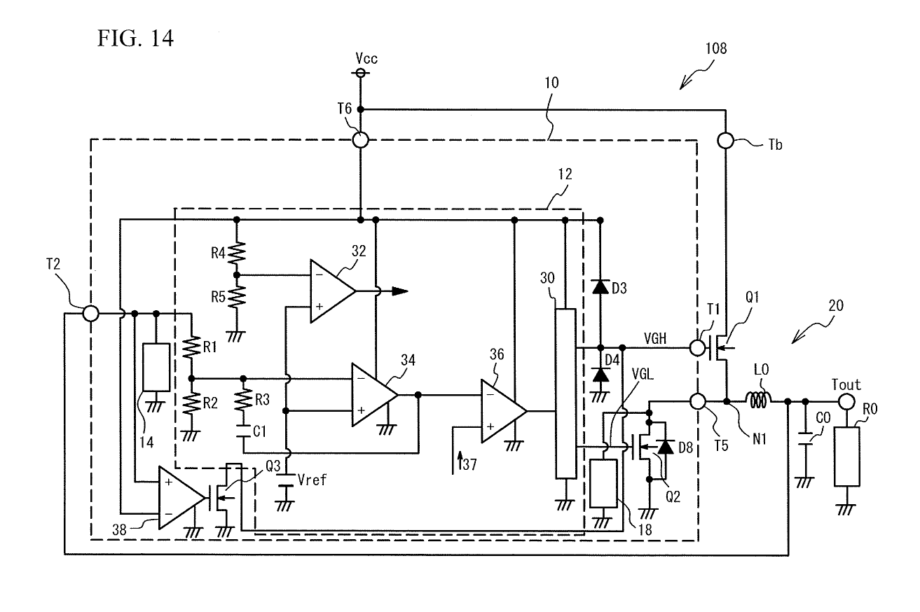

FIG. 14 is a circuit diagram of a power supply device in accordance with a variation of the seventh embodiment. Referring to FIG. 14, a power supply device 108 is configured to have the control device 10 that includes the transistor Q2 and the protection circuit 18. For example, the transistor Q2 is formed in a semiconductor chip in which the control device 10 is formed. The other structures of the variation are the same as those of the seventh embodiment illustrated in FIG. 13, and a description thereof is omitted here.

According to the seventh embodiment and its variation, the transistor Q3 sets the terminal T1 to the ground potential when the voltage of the power supply Vcc becomes equal to or lower than the voltage of the terminal T2.

According to the sixth and seventh embodiments and their variations, the transistor Q3 (switch) is turned ON when the voltage of the power supply Vcc is equal to or lower than the reference value (comparison value). The reference value may be the voltage of the output terminal Tout as in the case of the seventh embodiment, and may be set to an arbitrary voltage as in the case of the sixth embodiment. From a viewpoint of the suppression of the inverse current flows, it is preferable that the reference value is equal to or lower than the voltage of the output terminal Tout. It is thus possible to set the terminal T2 to the ground potential if the voltage of the power supply Vcc decreases. Thus, the power consumption is suppressed.

In the fourth through seventh embodiments and variations thereof, a switch may be connected between the terminal T3 or the gate of the transistor Q2 and the ground. The switch may be a transistor similar to the transistor Q3. The switch may be supplied with a signal that is the same as the control signal applied to the transistor Q3. It is thus possible to set the gate of the transistor Q2 to the ground potential if the voltage of the power supply Vcc is equal to or smaller than the reference value.

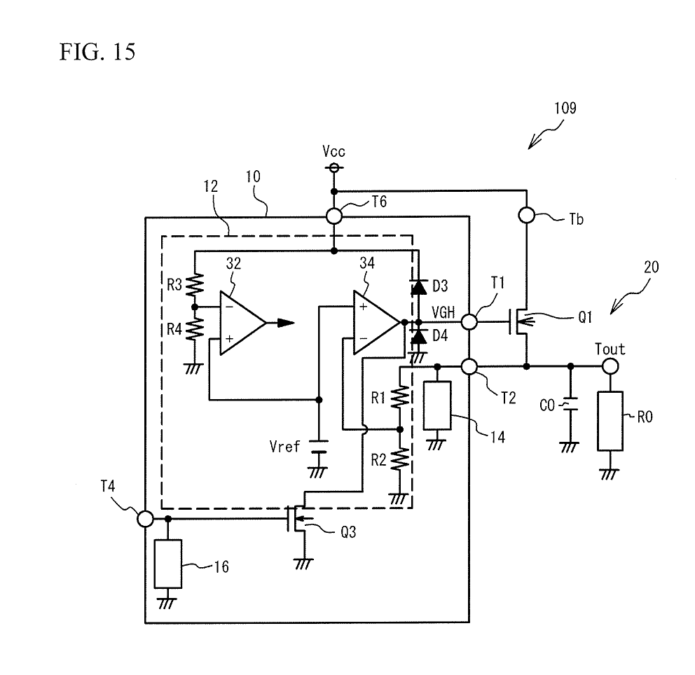

Eighth through tenth embodiments are exemplary linear regulators. FIG. 15 is a circuit diagram of a power supply device in accordance with the eighth embodiment. Referring to FIG. 15, a power supply device 109 is configured to have the transistor Q1 that is a transistor including GaN and to have the protection circuit 14 that causes surge current applied to the terminal T2 to flow to the ground to thus prevent it from flowing to the power supply Vcc. The transistor Q3 is used so that the drain is connected to the terminal T1 and the source is grounded, the gate being connected to the terminal T4. Further, the power supply device 109 has the protection circuit 16 that causes surge current applied to the terminal T4 to flow to the ground and thus prevents it from flowing to the power supply Vcc. The other structures of the eighth embodiment are the same as those of the second comparative example illustrated in FIG. 4, and a description thereof is omitted here.

According to the eight embodiment, the transistor Q1 includes GaN, and the protection circuit 14 is employed. It is thus possible to suppress the inverse current flow from the output terminal Tout to the power supply Vcc. Further, as in the case of the third embodiment, the transistor Q3 sets the terminal T1 approximately equal to the ground potential if the voltage of the power supply Vcc decreases. Thus, the power consumption is reduced. Furthermore, the protection circuit 16 suppresses the inverse current flow from the terminal T4 to the power supply Vcc even if the voltage of the power supply Vcc becomes lower than that of the terminal T4.

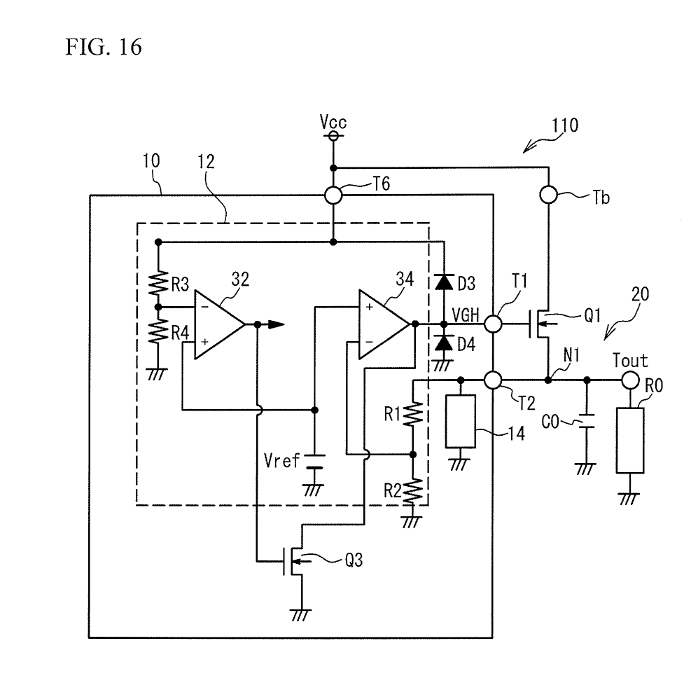

FIG. 16 is a circuit diagram of a power supply device in accordance with the ninth embodiment. Referring to FIG. 16, a power supply device 100 is configured so that the gate of the transistor Q3 is supplied with the output of the comparator 32. The other structures of the ninth embodiment are the same as those of the eighth embodiment illustrated in FIG. 15, and a description thereof is omitted here.

According to the ninth embodiment, the transistor Q3 is controlled by using the output of the comparator 32 that shuts down part of the power supply to the control circuit 12.

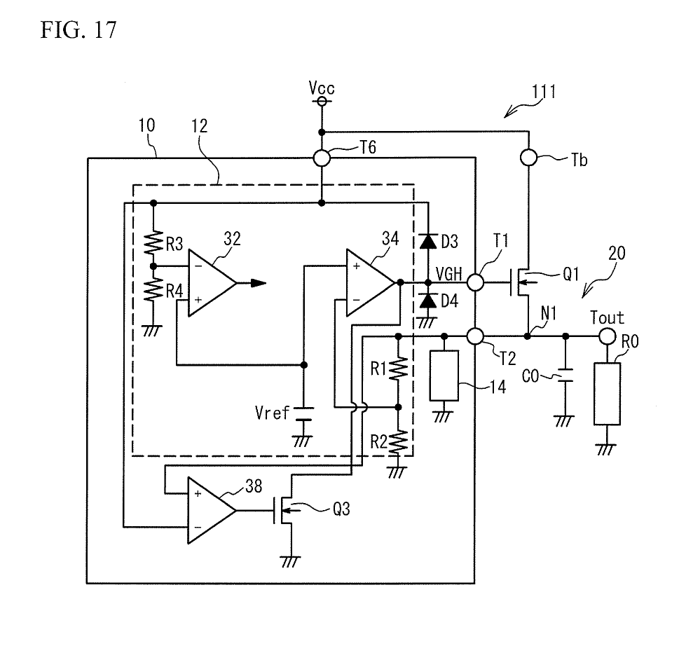

FIG. 17 is a circuit diagram of a power supply device in accordance with the tenth embodiment. Referring to FIG. 17, a power supply device 111 is configured to have the control device 10 that includes the comparator 38. The negative input terminal of the comparator 38 is connected to the terminal T6, and the positive input terminal is connected to the terminal T2. The comparator 38 outputs the high level to the gate of the transistor Q3 when the voltage of the power supply Vcc becomes equal to or lower than the voltage of the terminal T2. Thus, the transistor Q3 sets the terminal T1 to the ground potential when the voltage of the power supply Vcc becomes equal to or lower than the voltage of the terminal T2. The other structures of the tenth embodiment are the same as those of the eighth embodiment illustrated in FIG. 15, and a description thereof is omitted here.

In the seventh and eight embodiments, the transistor Q3 (switch) is turned on when the voltage of the power supply Vcc becomes equal to or lower than the reference value. It is thus possible to set the terminal T1 to the ground potential when the voltage of the power supply Vcc decreases and suppress the power consumption.

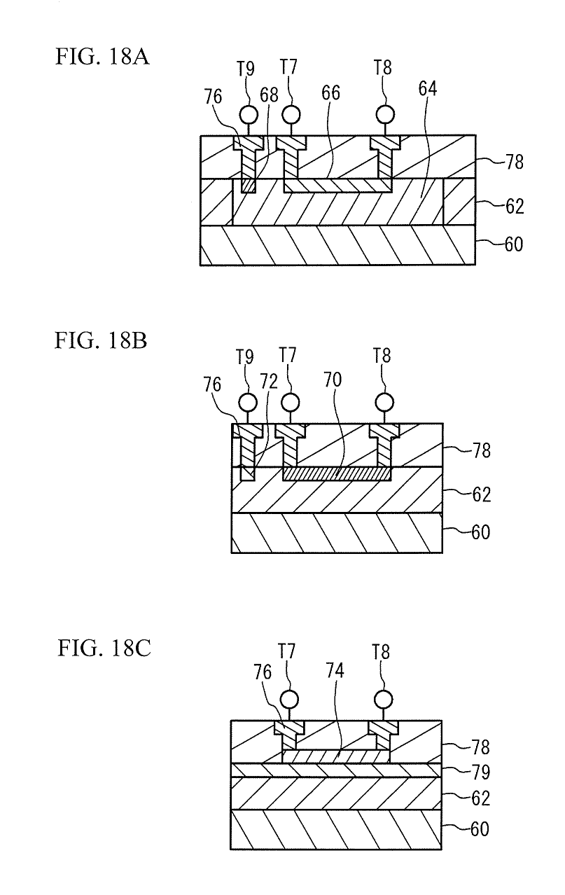

FIGS. 18A to 18C are cross-sectional views of resistors. Referring to FIG. 18A, a p-type diffusion resistor is now described. A p-type well 62 is formed in a p-type silicon substrate 60, and an n-type well 64 is formed in the p-type well 62. A p⁺ region 66 and an n⁺ region 68 are formed in the n-type well 64. An insulation film 78 including silicon oxide or the like is formed on the substrate 60. A via interconnection 76 that pierces through the insulation film 78 is formed. Terminals T7 and T8 are connected to opposite ends of the p⁺ region 66 via the respective via interconnections 76. A terminal T9 is connected to n⁺ region 68 via the corresponding via interconnection 76. The p⁺ region 66 is a p-type diffusion resistor, and has a resistance between the terminals T7 and T8. The terminal T9 is a terminal used to set the potential of the n-type well 64. The terminal T9 is supplied with a voltage higher than the voltages of the terminals T7 and T8 in order to prevent the forward current from flowing through the pn junction between the p⁺ region 66 and the n-type well 64.

Referring to FIG. 18B, an n-type diffusion resistor is described. The p-type well 62 is formed in the p-type silicon substrate 60. An n⁺ region 70 and a p⁺ region 72 are formed in the p-type well 62. The terminals T7 and T8 are connected to opposite ends of the n⁺ region 70 via the corresponding via interconnections 76. The terminal T9 is connected to the p⁺ region 72 via the corresponding via interconnection 76. The n⁺ region 70 is a p-type diffusion resistor. The terminal T9 is supplied with a voltage lower than the voltages of the terminals T7 and T8 in order to prevent the forward current from flowing through the pn junction between the n⁺ region 70 and the p-type well 62.

Referring to FIG. 18C, a polysilicon resistor is described. A polysilicon layer 74 is formed on the substrate 60 so that an insulation film 79 including silicon oxide is interposed therebetween. The polysilicon layer 74 is doped with n-type or p-type impurities. An insulation film 78 is formed on the polysilicon layer 74. The polysilicon layer 74 is a polysilicon resistor. Since the insulation film 79 is interposed between the polysilicon layer 74 and the substrate 60, there is no need for the setting of the potential of the well, which is carried out for the p-type and n-type diffusion resistors.

In the fourth through tenth embodiments, when the resistors R1 through R3 connected to the terminal T2 are p-type diffusion resistors, a positive potential is applied to the n-type well 64. However, if the voltage of the power supply Vcc becomes lower than the voltage of the output terminal Tout, a positive voltage is no longer generated. With the above in mind, it is preferable that the resistors R1 through R3 are n-type diffusion resistors or polysilicon resistors. It is thus possible to ensure the original function of the resistors R1 through R3 even if the voltage of the power supply Vcc becomes lower than the voltage of the output terminal tout.

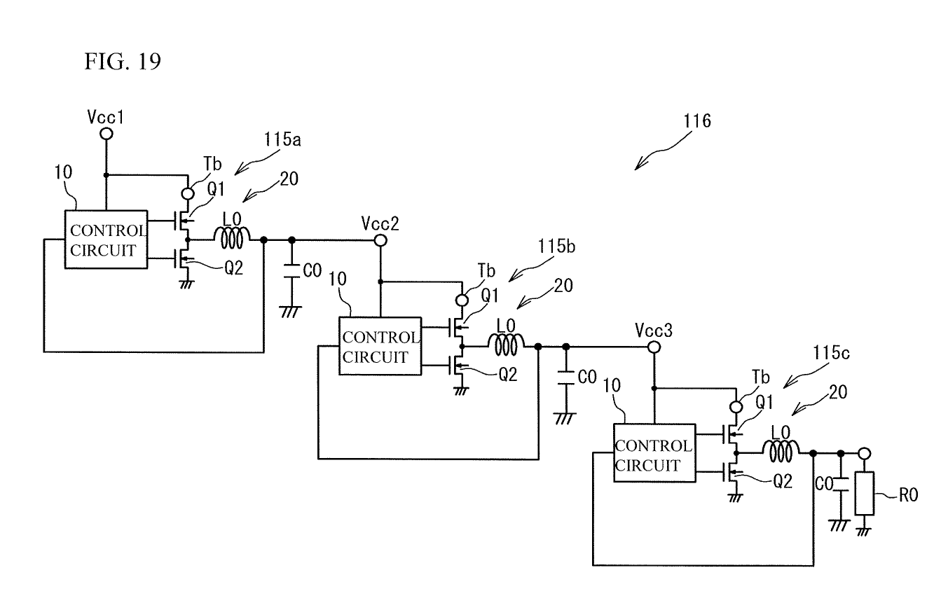

The eleventh embodiment is an exemplary power supply system using the DC-DC converter of any of the fourth through seventh embodiments. FIG. 19 is a circuit diagram of a power supply system in accordance with the eleventh embodiment. Referring to FIG. 19, a power supply system 116 includes a plurality of power supply devices 115a through 115c. Each of the power supply devices 115a through 115c includes the control device 10 and the power supply circuit 20. The power supply device 115a steps down a power supply voltage Vcc1 to a voltage Vcc2. The power supply device 115b steps down the voltage Vcc2 to a voltage Vcc3. The power supply device 115c steps down the voltage Vcc3 to a voltage that is to be applied to the load R0.

If each of the power supply devices 115a through 115c is the power supply device of the first comparative example, the power consumption may be suppressed by turning off the transistors Q1 and Q2 of the power supply device 115c. However, the voltages Vcc2 and Vcc3 are applied to the power supply devices 115b and 115c, respectively. Therefore, the suppression of power consumed in the power supply devices 115b and 115c is insufficient. In contrast, each of the power supply devices 115b and 115c is the power supply device of any of the fourth through seventh embodiments. It is thus possible to make the output voltage of the power supply device 115a lower than the voltage applied to the load R0. For example, the output voltage of the power supply device 115a may be set to the ground potential. As described above, the inverse current flow may be suppressed even if the output voltage of the power supply device 115a is lowered. Thus, the power consumption is suppressed if small current flows through the load R0.

The eleventh embodiment employs the DC-DC converters as the power supply devices. The eleventh embodiment may employ the linear regulators of any of the eighth through tenth embodiments or the power supply devices of any of the first through third embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A control device comprising:
a control circuit that controls a power supply circuit by a feedback of an output from an output terminal, the power supply circuit having a first transistor, the first transistor including gallium nitride material and having a source and a drain connected so that one of the source and the drain is connected to a first power supply and an other of the source and the drain is connected to the output terminal; and
a first terminal via which a first control signal output by the control circuit is output to a gate of the first transistor.

2. The control device according to claim 1, further comprising:
a second terminal connected to the output terminal; and
a first protection circuit that prevents surge current applied to the second terminal to the first power supply and causes the surge current to flow to a second power supply having a voltage lower than that of the first power supply.

3. The control device according to claim 2, further comprising a switch connected between the first terminal and the second power supply.

4. The control device according to claim 1, further comprising a switch connected between the first terminal and a second power supply having a voltage lower than that of the first power supply.

5. The control device according to claim 1, further comprising one of an n-type diffusion resistor and a polysilicon resistor connected to the second terminal.

6. The control device according to claim 1, wherein:
the power supply circuit includes a second transistor connected so that one of a source and a drain of the second transistor is connected to the other of the source and the drain of the first transistor, and an other of the source and the drain of the second transistor is connected to a second power supply having a voltage lower than that of the first voltage; and
the control device has a third terminal via which a second control signal output by the control circuit is output to a gate of the second transistor.

7. The control device according to claim 1, further comprising a second transistor connected so that one of a source and a drain of the second transistor is connected to the other of the source and the drain of the first transistor, and an other of the source and the drain of the second transistor is connected to a second power supply having a voltage lower than that of the first voltage,
wherein the control circuit outputs a second control signal to a gate of the second transistor.

8. The control device according to claim 6, wherein the power supply circuit includes an inductor having one end connected to the other of the source and the drain of the first transistor and an other end connected to the output terminal, and a capacitor having one end connected to the output terminal and an other end connected to the second power supply.

9. The control device according to claim 7, wherein the power supply circuit includes an inductor having one end connected to the other of the source and the drain of the first transistor and an other end connected to the output terminal, and a capacitor having one end connected to the output terminal and an other end connected to the second power supply.

10. The control device according to claim 3, further comprising a third terminal to which a third control signal that turns on or off the switch is input.

11. The control device according to claim 4, further comprising a third terminal to which a third control signal that turns on or off the switch is input.

12. The control device according to claim 10, further comprising a second protection circuit that causes a surge current applied to the fourth terminal to the second power supply.

13. The control device according to claim 11, further comprising a second protection circuit that causes a surge current applied to the fourth terminal to the second power supply.

14. The control device according to claim 3, wherein the switch turned on when a voltage of a sixth terminal connected to the first power supply is equal to or smaller than a reference value.

15. The control device according to claim 4, wherein the switch is turned on when a voltage of a sixth terminal connected to the first power supply is equal to or smaller than a reference value.

16. The control device according to claim 7, further comprising:
a fifth terminal connected to the other of the source and the drain of the first transistor; and
a third protection circuit that prevents a surge current applied to the fifth terminal from flowing to the first power supply and causes the surge current to flow to the second power supply.

17. A power supply device comprising:
a control device; and
a first transistor including GaN having a source and a drain,
the control device including a control circuit that controls a power supply circuit by a feedback of an output from an output terminal, the power supply circuit having the first transistor connected so that one of the source and the drain is connected to a first power supply and an other of the source and the drain is connected to the output terminal; and
a first terminal via which a first control signal output by the control circuit is output to a gate of the first transistor.
